(19) United States
(12) Patent Application Publication
(10) Pub. No.: US 2007/0251368 A1
(43) Pub. Date: Nov. 1, 2007

(54) Cutting knife with inserts and method of manufacture thereof

(75) Inventor: Claude McFarlane, Fitchburg, WI (US)

Correspondence Address: OBLON, SPIVAK, MCCLELLAND, MAIER & NEUSTADT, P.C., 1940 DUKE STREET, ALEXANDRIA, VA, 22314, US

(73) Assignee: KUHN KNIGHT, INC., Brodhead, WI (US)

(21) Appl. No.: 11/411,943

(22) Filed: Apr. 27, 2006

(51) Int. Cl. B26D 7/00

(52) U.S. Cl. 83/649

(57) ABSTRACT

A knife assembly includes a knife plate with a leading edge, and a cutting element cemented to the leading edge via a brazing process. The knife plate is heat-treated after the cutting element is cemented to the leading edge so as to form a heat-treatment area on the leading edge. Also disclosed is a method of manufacturing a knife assembly including, forming a leading edge on a side of a knife plate, forming a slot in the leading edge, inserting, into the slot, an insert, brazing the insert to the knife plate after the insert is inserted into the slot, and heat-treating at least a portion of the knife plate after the brazing.

### CROSS-REFERENCE TO RELATED APPLICATIONS

Not Applicable

### BACKGROUND OF THE INVENTION

1. Field of the Invention

This invention relates to a cutting knife, for example, a cutting knife used for agricultural mixers. Additionally, this invention relates to a method of manufacture of a cutting knife with inserts. In one embodiment, the present invention is directed to a knife used in a vertical-type feed mixer.

2. Discussion of the Background

Agricultural mixers are used for mixing hay and silage together with other nutrients including animal feed supplements and grains. These feed materials are then discharged and fed to various livestock such as cattle and dairy cows. Sometimes the mixing of such feed includes depositing a whole round hay bale into the mixer and processing to the desired consistency before and during the mixing of the other feed ingredients.

In known feed mixers there are many different configurations including horizontal augers, reel type arrangements, and vertical augers. Each of these arrangements utilizes one or more augers with cutting knives or blades to facilitate the processing of long stemmed materials such as hay or other forages.

Known cutting knives typically include a steel plate, which is profiled into various sizes and shapes and sharpened to create a cutting edge, and designed to be attached to the moving auger or other mixing means. In some cases these cutting knives are attached to a stationary surface inside the mixer, and the material is moved across the cutting edges. In the process of mixing the feed materials, long stemmed hay and forages are forced across the sharpened surfaces of the knives, cutting the material into shorter sections which is more desirable for the livestock to eat.

The sharpened cutting surfaces of the knives can wear quickly, and thus many designs and methods have been attempted to attain a knife that maintains a sharp edge for a long period of time without being brittle. One such method is a simple heat-treating of the steel surface to increase the hardness and thus the durability and strength thereof. Another method is to add an abrasion resistant material to the knife. The abrasion resistant material is fused at high temperature to the cutting edge, then heat-treated for strength. The abrasion resistant material is more durable than the base material, so the knife tends to maintain a sharp edge as the base material wears. Another method is to heat-treat the knife, then cement (braze) carbide inserts onto the leading edge. However, this method results in a loss of beneficial properties of the heat-treatment in areas that are re-heated during the cementing process. One disadvantage of conventional heat-treated knives is that the sharpened edges become dull quickly, despite the hardened edge created by the heat-treatment.

One disadvantage of a knife with the abrasion resistant material is that the heat-treating on the base material must be such that the base material wears faster than the abrasion treated edge. This often requires that a backer plate be added directly behind the base plate for added strength.

A conventional type of knife is a knife with stepped teeth, which includes an insert cemented on two edges. One disadvantage of knives with stepped teeth and carbide inserts is that the abrasion resistance of the knife body is compromised when the carbide is cemented into position because the benefit of heat-treatment in the area of the inserts is somewhat nullified by the high temperature required for brazing.

A disadvantage of knives with stepped teeth and carbide inserts is that the carbide, which can be expensive, is normally present in the full length of the steps because the steps are designed as the mounting surface for the carbide and do not have a sharp edge themselves.

Another disadvantage of knives with stepped teeth and carbide inserts is that since the ends of the carbide inserts are normally perpendicular to the cutting edges, they do not fit tightly into the acute or obtuse angle of the steps if the leading edge are curved.

Another disadvantage of typical knives with stepped teeth and carbide inserts is that the carbide can only be cemented on two edges, leaving one end vulnerable to impact and damage.

### SUMMARY OF THE INVENTION

Accordingly, it is an objective of an exemplary embodiment of the present invention to provide a cutting knife which overcomes some or all of the problems associated with known devices and makes a considerable contribution to the art of mixing materials.

Other objects and advantages of exemplary embodiments of the present invention are one or more of the following:

a) to provide a knife with a carbide insert to increase the anticipated life of the sharpened edge;
a) to provide a knife in which carbide inserts are brazed into position prior to heat treating;
b) to provide a knife in which the base material is heat treated after the carbide inserts are cemented into position;
c) to provide a knife in which the cutting elements are not the full length of the repeating pattern of the sharpened leading edge;
d) to provide a knife in which the leading edge can be shaped straight, concave, or convex, without affecting the design of the cutting elements;
e) to provide a knife in which the cutting elements are cemented on three sides of the knife plate for added strength and durability; and
f) to provide a knife which is through-hardened for strength and wear, with enough flexibility to not require a support backing plate.

Accordingly, one aspect of the present invention includes a knife assembly with a knife plate including a leading edge. This aspect of the present invention can further include a cutting element cemented to the leading edge with brazing material via a brazing process. The knife plate can be heat-treated after the addition of the cutting element so as to form a heat-treatment area on the leading edge. Furthermore, the heat-treatment area can be substantially unaffected by the brazing process.

Another aspect of the present invention includes a knife assembly including a knife plate with a leading edge and a cutting element cemented to the leading edge via a brazing process.

Another aspect of the present invention includes a method of manufacturing a knife assembly including; forming a leading edge on a side of a knife plate comprising a first material, forming a slot in the leading edge, inserting, into the slot, an insert comprising a second material different from the first material, brazing the insert to the knife plate with a brazing material after the insert is inserted into the slot, and heat-treating at least a portion of the knife plate after the brazing. A hardness of the portion of the knife plate after heat-treating can be different than a hardness of the portion of the knife plate before the heat-treating.

### BRIEF DESCRIPTION OF THE DRAWINGS

These and other advantages of the invention will become more apparent and more readily appreciated from the following detailed description of the exemplary embodiments of the invention taken in conjunction with the accompanying drawings, where;

FIG. 1 is an isometric view of one exemplary embodiment of a knife with cutting elements.

FIG. 2 is an isometric view of the knife of FIG. 1 with the cutting elements removed.

FIG. 3 is an isometric view from below the knife of FIG. 1.

FIG. 4 is an isometric view of a convex knife according to one non-limiting embodiment of the invention.

### DETAILED DESCRIPTION OF THE INVENTION

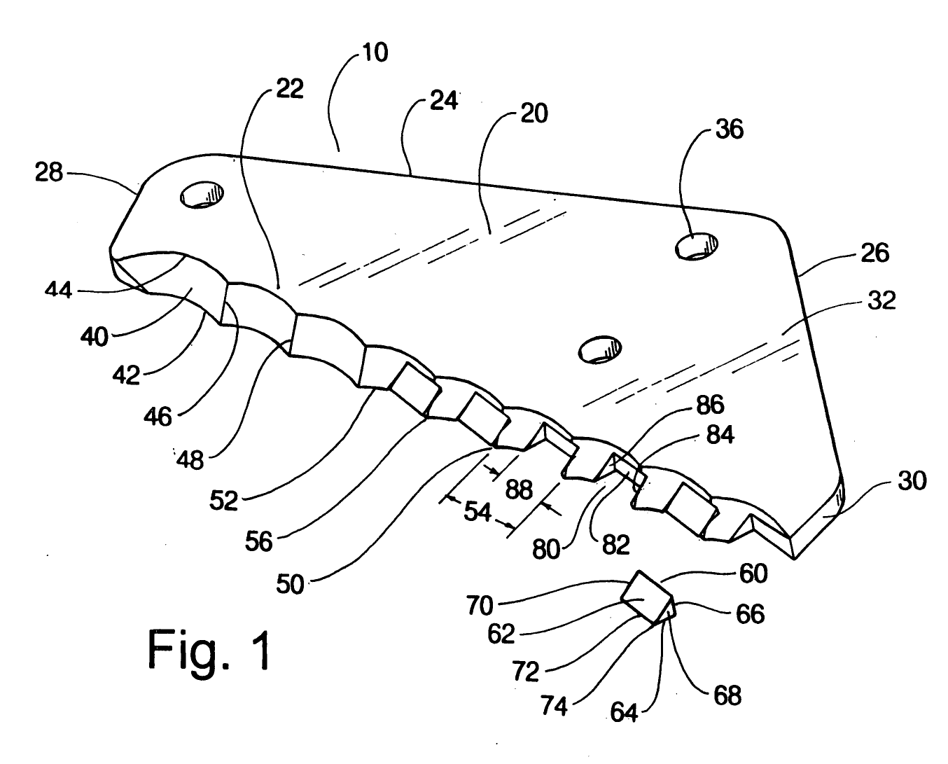

The invention is best understood from the following detailed description when read in conjunction with the accompanying drawings. With reference to FIGS. 1 through 3, one exemplary embodiment of the present invention is a knife 10 including a plate 20 having a leading edge 22, which is sharpened to form a cutting knife such as those used in agricultural feed mixers. By way of example, a feed mixer can be of a variety of configurations, but generally includes a large bin with at least one rotating mixing device or auger on which the knives 10 are typically mounted.

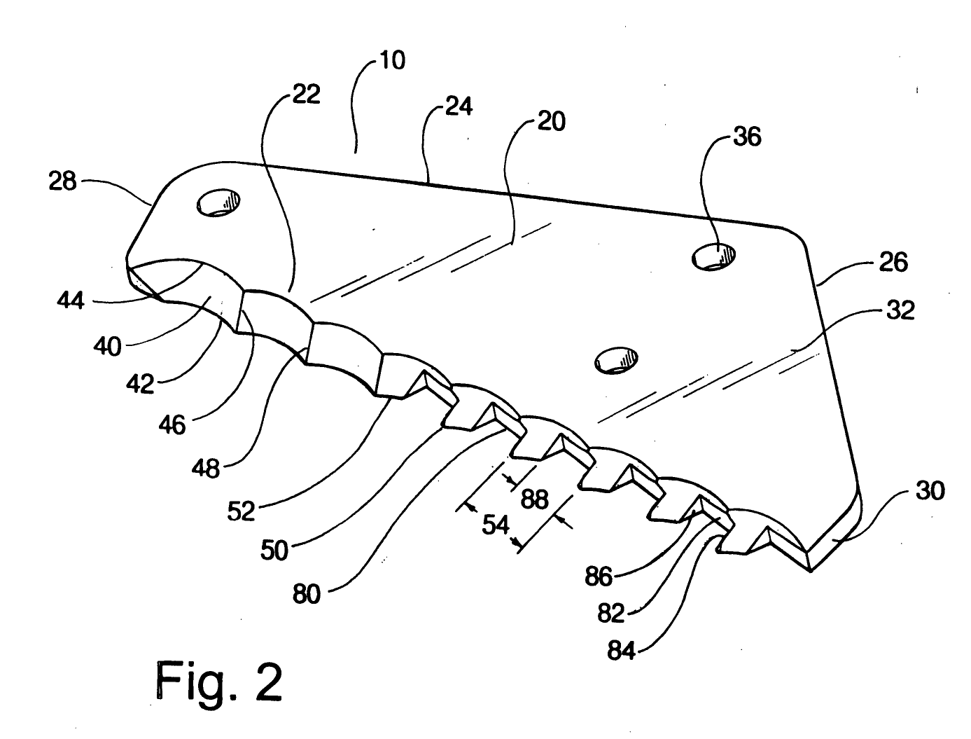

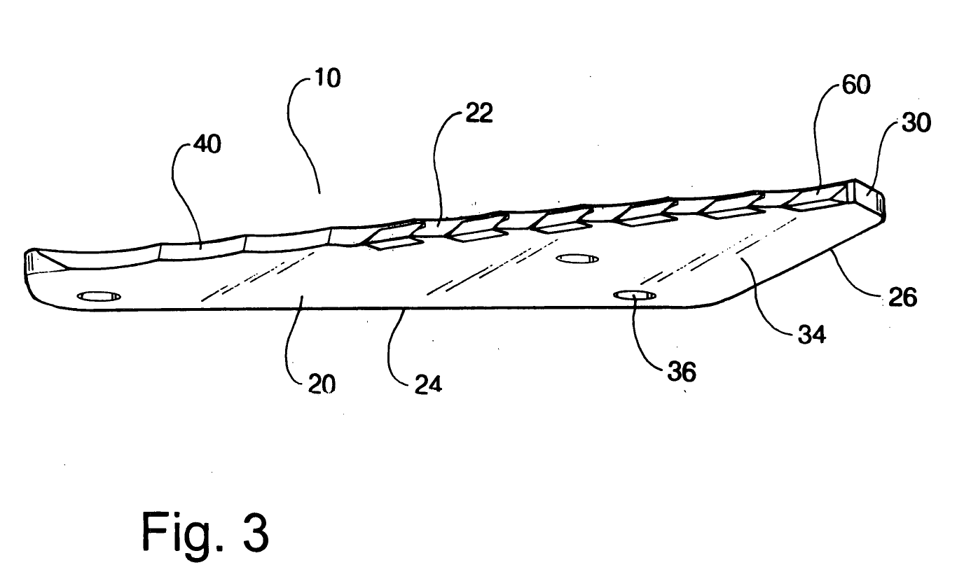

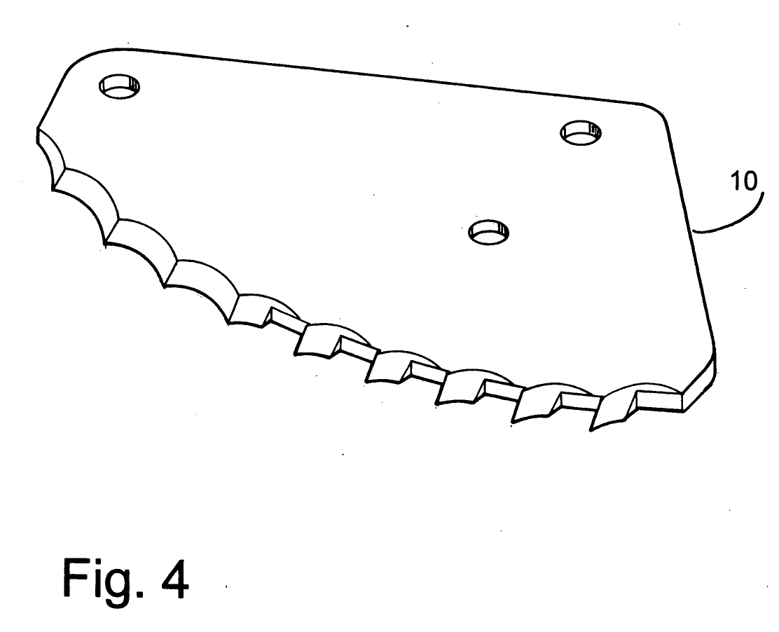

In the exemplary embodiment of FIGS. 1 and 2, plate 20 of the knife 10 also includes a first rear edge 24, a second rear edge 26, a heel edge 28, and a toe edge 30. When mounted in a working position, the toe edge 30 normally faces toward the outer perimeter of the rotating mixing device, while the heel edge 28 faces toward the centerline of the rotating mixing device. The leading edge 22 faces forward in the direction of rotation of the mixing device. The plate 20 also has a top surface 32 and a bottom surface 34 (see FIG. 3). There are also a plurality of mounting holes 36 which are used to attach the knife 10 to the mixing device of the feed mixer. In addition to, or in place of the mounting holes 36, other modes of attachment are available such as, by way of non-limiting example: clamping, fixing with keys and keyways, and bonding. Furthermore, other general shapes of the knife 10 are possible. For example, the knife 10 may be substantially half-moon shaped so that the leading edge 22 is concave or convex as shown in FIG. 4. Alternatively, the knife 10 may be substantially rectangular. Moreover, the other sections of the plate 20 may be shaped differently to assist attachment of the plate 20 to a mixing device.

The leading edge 22 is sharpened to form sharpened faces 40 which can be scallop-shaped. Each sharpened face 40 typically has a lower edge 42, an upper edge 44, a back edge 46, and a front edge 48. At the intersection of the lower edge 42 and the front edge 48 is a leading corner 50. These leading corners 50 create a repeating pattern 56 of sharpened faces 40, which can be measured by a pattern length 54. It is to be understood that the sharpened faces could also be manufactured using a plurality of straight cuts at various angles, to form the basic curved shape. The sharpened faces could also be made with a series of straight cut steps. It is not necessary that the pattern length be constant over the entire length of the knife 10, changes in the pattern length are possible. For example, it is possible for the size of the sharpened faces 40 to increase or decrease as they progress from the heel edge 28 to the toe edge 30.

In order to increase the life of the leading edge 22, cutting elements 60 may be utilized. The cutting element 60 is generally triangular in cross section, or wedge shaped. However any other shape with a forward cutting edge may be used. The cutting elements of FIGS. 1-3 have a top surface 62, a bottom surface 64, and a rear surface 66. If, for example, the cutting elements 60 are pie-shaped, triangular, or semi-circular, one or more of the top 62, bottom 64, and rear 66 surfaces may be combined or altered. The cutting element 60 typically includes a front end surface 68 and a rear end surface 70. The intersection of the top surface 62 and the bottom surface 64 forms the cutting edge 72. The intersection of the top surface 62, the bottom surface 64 and the front end surface 68 defines a front corner 74.

In order to adequately mount the cutting element 60 into the plate 20, a plurality of slots 80 are created in the leading edge 22. Each slot 80 can have several relatively flat faces, including a slot back face 82, a slot front face 84 which is towards the toe edge 30 of the plate 20, and a slot rear face 86 which is towards the heel edge 28 of the plate 20. If the shape of the cutting elements 60 is different from that shown, the shape of the slots 80 will correspond, match, or approximate the shape of the cutting elements 60. The distance between the slot front face 84 and the slot rear face 86 define a slot length 88. The cutting elements 60 are preferably cemented into place at all three mating surfaces (or at whatever surface of the slot 80 is configured to mate with the cutting element 60), with the rear end surface 66 of the cutting element 60 adjacent to the slot back face 82 of the slot 80, the front end surface 68 of the cutting element 60 adjacent to the slot front face 84 of the slot 80, and the rear end surface 70 of the cutting element 60 adjacent to the slot rear face 86 of the slot 80. The ability to firmly cement all three of the mating surfaces gives the cutting element 60 a firm base for attachment. Moreover, if each of the three mating surfaces of the cutting element 60 are covered (abutted) or partially covered by the surfaces of the slot 80, the slot faces at least partially protect the cutting element 60 from impact and damage. It should be noted that in some cases, it may be desirable to cement only a portion of each of the three faces. Moreover, it may be beneficial, in some cases, to cement part or all of only two of the faces of the cutting element 60.

The slot front face 84 of the slot 80 is generally adjacent to the leading corner 50 of the sharpened face 40. The result is that the cutting elements 60 can be cemented into the slots 80 so that the front corner 74 of the cutting element 60 is coincident with the leading corner 50 of the sharpened face 40. This way, the cutting elements 60 can be positioned where most of the cutting is being performed. Therefore, the cutting elements 60 do not need to occupy the entire length of the sharpened face 40. The remaining portion of the sharpened face 40 (after accounting for the slot 80) is a partial lower edge 52, which continues to cut the materials as the material slides past the cutting element 60. In the embodiment shown in FIG. 1, the slot 80 extends into the leading edge 22 so as to at least partially overlap the front edge 48.

In other embodiments, the slot 80 can be offset from the front edge 48. To assist the cutting performed by the cutting elements 60, the lower edge 52 can be in substantially the same plane as the cutting edge 72. Slight deviations are possible without degradation of the overall cutting power of the knife 10. Typically, at least the lower edge 52 of the plate 20 is heat-treated. Such heat-treatment hardens the material, especially the surface of the material. Therefore, the lower edge 52 retains its sharpness for a longer period of use. The effect and extent of heat-treatment depends on the temperatures used and the duration of time for which a given object is heat-treated. For example, some heat-treatments affect the entire thickness of the heat-treated object. Other heat-treatments harden only the material near the surface.

The heat-treatment is typically carried out in a temperature-controlled salt bath at a temperature of 1550-1575° F. Further, the heat-treatment is preferably performed as austempering. However, other heat-treatments can be used.

As cutting elements 60 can be made of a more expensive material than the material used in the plate 20, the use of a combination of cutting element 60 and the partial lower edge 52 can result in a significant cost savings over conventional knives, which apply their cutting elements 60 to the entire length of the leading edge 22.

The cutting elements 60 can be composed of a variety of different materials, for example, a combination of tungsten carbide and cobalt can work well in these applications. The cutting elements 60 can be cemented into place using a brazing process. The cement used preferably melts at a temperature higher than that required in any subsequent heat-treatment of the finished part.

In some embodiments, the brazing is so-called “high temperature brazing.” In that case, the temperature of the brazing process occurs at 1615° F. or higher. Other embodiments use so-called “low temperature brazing.” In that case, the temperature is held at 1100° to 1200° F. In either case, the brazing material will typically have a melting point at least 75° higher than the temperature at which heat-treatment occurs. Thus, when high-temperature brazing is used, the melting point of the brazing material is 1690° F. or higher. A preferred brazing material used in the brazing process is LUCAS MILHAUPT HI-TEMP 548, but other brazing materials can be used.

By attaching the cutting elements 60 to the plate prior to heat treating the knife 10, the plate 20 can be fully heat-treated and the cutting elements 60 can be solidly attached. In other words, the area around the cutting elements 60 is heat treated, and the heat-treatment is not later degraded during heating required by the brazing process. Thus, the hardness (and, therefore, the durability) of the lower edge 52 is enhanced compared to edges that are heat-treated only before a brazing process is performed. Said differently, by heat-treating the leading edge 22 after the cutting elements are attached, the efficiency of the knife 10 improves because the sharpness of the leading edge lasts longer. Furthermore, as the present invention allows multiple small inserts to be brazed into the plate 20 without degradation of the heat-treatment effect, the knife 10 can be better shaped to optimize the cutting process.

In order to achieve different cutting performance, the leading edge 22 can be straight (as shown), or manufactured with a convex or concave arc. Because the cutting elements 60 typically do not span the entire length of the sharpened face 40, more options for the shape of the leading edge contour are possible with less machining done to the carbide material itself.

Obviously, numerous modifications and variations of the present invention are possible in light of the above teachings. It is therefore to be understood that, within the scope of the appended claims, the invention can be practiced otherwise than as specifically described herein.

What is claimed is:

1. A knife assembly comprising:
a knife plate including a leading edge; and
a cutting element cemented to said leading edge with brazing material via brazing, wherein said knife plate is heat-treated after said cutting element is cemented to said leading edge so as to form a heat-treatment area on the leading edge.

2. The knife assembly of claim 1, wherein a hardness of said heat-treatment area is substantially unaffected by the brazing.

3. The knife assembly of claim 1, wherein said knife plate comprises steel.

4. The knife assembly of claim 1, wherein said knife plate includes at least one mounting hole.

5. The knife assembly of claim 1, wherein said brazing material is substantially unaffected by a temperature required for heat-treating said knife plate.

6. The knife assembly of claim 1, wherein said brazing material has a melting point higher than a temperature used for heat-treating said knife plate.

7. The knife assembly of claim 1, wherein said leading edge includes a plurality of cutting elements cemented thereto.

8. The knife assembly of claim 7, wherein said cutting elements are wedge shaped.

9. The knife assembly of claim 7, wherein said cutting elements comprise tungsten carbide.

10. The knife assembly of claim 1, wherein said leading edge is sharpened in a repeating pattern.

11. The knife assembly of claim 10, wherein said repeating pattern includes a repeated pattern length.

12. The knife assembly of claim 11, wherein said leading edge further includes slots.

13. The knife assembly of claim 12, wherein said slots include a slot front face, a slot rear face, and a slot back face.

14. The knife assembly of claim 13, wherein said slot front face and said slot rear face are parallel to each other.

15. The knife assembly of claim 13, wherein said repeating pattern includes a leading corner.

16. The knife assembly of claim 15, wherein said slot front face is adjacent to said leading corner.

17. The knife assembly of claim 12, wherein said slots define a slot length.

18. The knife assembly of claim 17, wherein said slot length is shorter than said pattern length.

19. The knife assembly of claim 1, wherein said leading edge includes a plurality of slots.

20. The knife assembly of claim 19, wherein said slots have front, rear, and back faces.

21. The knife assembly of claim 20, wherein said cutting elements are cemented to each of said front, rear, and back faces of said slot.

22. The knife assembly of claim 1, wherein said leading edge is configured in a convex shape.

23. The knife assembly of claim 1, wherein said leading edge is configured in a concave shape.

24. The knife assembly of claim 1, wherein said brazing is high temperature brazing.

25. The knife assembly of claim 24, wherein the brazing material has a melting temperature at least 75° F. higher than the temperature at which the brazing occurs.

26. A knife assembly comprising:
a knife plate including a leading edge; and
a cutting element cemented to said leading edge via high temperature brazing.

27. The knife assembly according to claim 26, wherein said knife plate is heat-treated, after said cutting element is cemented to said leading edge.

28. The knife assembly according to claim 27, wherein a surface of said leading edge in close proximity to said cutting element is harder than an interior of said leading edge also in close proximity to said cutting element.

29. The knife assembly according to claim 26, wherein said leading edge is sharpened into a shape with a repeating pattern.

30. The knife assembly according to claim 29, wherein said repeating pattern defines a pattern length.

31. The knife assembly according to claim 30, wherein said leading edge further includes slots.

32. The knife assembly according to claim 31, wherein said slots define a slot length.

33. The knife assembly according to claim 32, wherein said slot length is shorter than said pattern length.

34. An auger assembly comprising:
an auger; and
a knife assembly according to claim 26, wherein said knife assembly is coupled to said auger.

35. A method of manufacturing a knife assembly comprising:
forming a leading edge on a side of a knife plate comprising a first material;
forming a slot in the leading edge;
inserting, into the slot, an insert comprising a second material different from the first material;
brazing the insert to the knife plate with a brazing material after the insert is inserted into the slot; and
heat-treating at least a portion of the knife plate after the brazing.

36. The method of manufacturing a knife assembly according to claim 35, wherein the heat-treating occurs at a temperature below a melting point of the brazing material.

37. The method of manufacturing a knife assembly according to claim 36, wherein the heat-treating occurs at a temperature at least 75° below the melting point of the brazing material.

38. The method of manufacturing a knife assembly according to claim 37, wherein the brazing occurs at a temperature of at least 1615° F.

39. The method of manufacturing a knife assembly according to claim 35, wherein the heat-treating hardens a surface of the leading edge.

40. The method of manufacturing a knife assembly according to claim 35, wherein forming a leading edge includes sharpening the leading edge to create a repeating pattern.

41. The method of manufacturing a knife assembly according to claim 40, wherein the sharpening includes forming a cutting edge on the leading edge in substantially the same plane as a cutting edge on the insert.

42. The method of manufacturing a knife assembly according to claim 35, wherein forming a slot includes forming a plurality of slots, and inserting an insert includes inserting a plurality of inserts.

43. The method of manufacturing a knife assembly according to claim 35, further comprising forming through-holes in the knife plate.

44. The method of manufacturing a knife assembly according to claim 35, wherein the insert is at least partially abutted on at least three faces by the slot.

45. The method of manufacturing a knife assembly according to claim 35, wherein a hardness of the portion of the knife plate after heat-treating is different from a hardness of the portion of the knife plate before the heat-treating.
